(19) United States
(12) Patent Application Publication
(10) Pub. No.: US 2025/0310959 A1
(43) Pub. Date: Oct. 2, 2025

(54) HARQ-ACK TRANSMISSIONS

(71) Applicant: ZTE CORPORATION, Shenzhen, Guangdong (CN)

(72) Inventors: Jianqiang DAI, Shenzhen, Guangdong (CN); Bo DAI, Shenzhen, Guangdong (CN); Jun XU, Shenzhen, Guangdong (CN); Mengzhu CHEN, Shenzhen, Guangdong (CN)

(21) Appl. No.: 18/866,575

(22) PCT Filed: Aug. 9, 2022
(86) PCT No.: PCT/CN2022/111233

§ 371 Date: Nov. 18, 2024

(51) Int. Cl. H04W 72/1273; H04L 1/1867; H04L 5/00; H04W 72/0446

(52) U.S. Cl. CPC H04W 72/1273; H04L 1/1887; H04L 5/0055; H04W 72/0446

(57) ABSTRACT

An example method includes receiving scheduling information for a plurality of downlink transmissions. The method further includes mapping a subset of the plurality of downlink transmissions to each of a plurality of time slots based on the scheduling information. The method further includes transmitting, in each time slot of the plurality of time slots to the network device, an acknowledgement message for the subset of downlink transmissions that is mapped to the time slot. In some examples, the acknowledgement message for each time slot includes hybrid automatic repeat request (HARQ) acknowledgement values (or negative acknowledgement values) for the subset of downlink transmissions mapped to the time slot.

### TECHNICAL FIELD

This disclosure is directed generally to digital wireless communications.

### BACKGROUND

Mobile telecommunication technologies are moving the world toward an increasingly connected and networked society. In comparison with the existing wireless networks, next generation systems and wireless communication techniques will need to support a much wider range of use-case characteristics and provide a more complex and sophisticated range of access requirements and flexibilities.

Long-Term Evolution (LTE) is a standard for wireless communication for mobile devices and data terminals developed by 3rd Generation Partnership Project (3GPP). LTE Advanced (LTE-A) is a wireless communication standard that enhances the LTE standard. The 5th generation of wireless system, known as 5G, advances the LTE and LTE-A wireless standards and is committed to supporting higher data-rates, large number of connections, ultra-low latency, high reliability and other emerging business needs.

### SUMMARY

Techniques are disclosed for providing hybrid automated repeat request (HARQ) feedback in multiple slots. In some examples, HARQ feedback for multiple downlink transmissions that are scheduled by a downlink control information (DCI) is transmitted in multiple uplink slots.

In one exemplary aspect, a method for wireless communication is described. The method includes receiving, from a network device, scheduling information for a plurality of downlink transmissions. The method further includes mapping a subset of the plurality of downlink transmissions to each of a plurality of time slots based on the scheduling information. The method further includes transmitting, in each time slot of the plurality of time slots, an acknowledgement message for the subset of downlink transmissions that is mapped to the time slot to the network device.

In some embodiments, at least one of the plurality of time slots is before a time slot that is a minimum time offset after an end of the plurality of downlink transmissions. In some embodiments, the plurality of time slots are after a time slot that is a minimum time offset after a start of the plurality of downlink transmissions.

In some embodiments, the method further includes identifying the plurality of time slots to which subsets of downlink transmissions are mapped. The plurality of time slots are identified for transmission of hybrid automatic repeat request (HARQ) acknowledgement messages in response to the mapped subset of downlink transmissions.

In some embodiments, mapping the subset to each time slot is performed in response to receiving an instruction for transmission of acknowledgement messages in multiple time slots from the network device. In some embodiments, mapping the subset to each time slot is performed in response to not receiving an acknowledgement timing parameter that indicates a given time offset for transmission of one acknowledgement message for the plurality of downlink transmissions after an end of the plurality of downlink transmissions. In some embodiments, mapping the subset to each time slot is performed in response to determining that one or more time slots exist between a time slot at which the scheduling information was received and a last time slot that is indicated by an acknowledgement timing parameter.

In some embodiments, each subset is determined to include downlink transmissions that each occur at least a minimum delay before the mapped time slot for transmission of the acknowledgement message for the subset. In some embodiments, the minimum delay is indicated by a received radio resource control (RRC) signaling or by the scheduling information.

In some embodiments, subsets of downlink transmissions are mapped to the plurality of time slots based on: identifying the plurality of time slots to be a first time slot and a second time slot, and mapping a first subset to the first time slot and a second subset to the second time slot based on assigning each of the plurality of downlink transmissions to one of the first time slot or the second time slot. The second time slot is indicated by the scheduling information, and the first time slot is the latest time slot before the second time slot. In some embodiments, each downlink transmission is assigned to one of the first time slot or the second time slot based on whether the downlink transmission occurs at least a minimum delay before the first time slot or the second time slot.

In some embodiments, the subset is mapped to each of the plurality of time slots based an indication of two or more particular time slots that divide the plurality of downlink transmissions into subsets.

In some embodiments, mapping the subset to each time slot includes: identifying a N number of downlink transmissions scheduled for consecutive time slots; mapping a first subset that includes a first N−1 downlink transmissions to a first time slot; and mapping a second subset that includes a N-th downlink transmission to a second time slot.

In some embodiments, a number of downlink transmissions in the subset mapped to each of the plurality of time slots is less than a threshold number. In some embodiments, the threshold number is less than or equal to half of a total number of the plurality of downlink transmissions.

In some embodiments, the method further includes determining whether each of the plurality of downlink transmissions was received correctly; and generating, for each downlink transmission belonging to the subset mapped to a given time slot, an acknowledgement value (ACK) or a negative acknowledgement value (NACK) in the acknowledgement message depending on whether the downlink transmission was received correctly. In some embodiments, the method further includes transmitting the acknowledgement message at a time slot that is not indicated by a value of a PDSCH-to-HARQ feedback timing indicator.

In some embodiments, the plurality of downlink transmissions include one or more candidate physical downlink shared channel (PDSCH) receptions or one or more semi-persistent scheduling (SPS) PDSCH releases.

In another exemplary aspect, another method for wireless communication is described. The method includes transmitting, to a wireless communication device, scheduling information for a plurality of downlink transmissions. The method further includes receiving from the wireless communication device and in each time slot of a plurality of time slots, an acknowledgement message for a subset of the downlink transmissions that is mapped to the time slot.

In some embodiments, at least one of the plurality of time slots in which the acknowledgement message is received is before a time slot that is a minimum time offset after an end of the plurality of downlink transmission.

In some embodiments, the plurality of time slots are after a time slot that is a minimum time offset after a start of the plurality of downlink transmissions.

In some embodiments, the method further includes transmitting, to the wireless communication device, an instruction for transmission of acknowledgement messages across the plurality of time slots.

In some embodiments, the method further includes transmitting, to the wireless communication device, an indication of two or more particular time slots that divide the plurality of downlink transmissions into subsets.

In some embodiments, the method further includes transmitting, to the wireless communication device, an indication of a number of the plurality of downlink transmissions to include in the subset that is mapped to each time slot.

In some embodiments, the method further includes constraining a number of downlink transmissions for the subset that is mapped to each time slot to be less than or equal to half of a total number of the plurality of downlink transmissions.

In some embodiments, the method further includes decoding the acknowledgement message that is received at a given time slot to determine whether each of the subset of the downlink transmissions was received correctly by the wireless communication device.

In some embodiments, the acknowledgment message is decoded based on the acknowledgement message including a HARQ-ACK value or a HARQ-NACK value that indicates whether or not each downlink transmission was received correctly by the wireless communication device.

In some embodiments, the method further includes scheduling a re-transmission of a particular downlink transmission that is indicated with a HARQ-NACK value in acknowledgement message.

In some embodiments, the plurality of downlink transmissions includes one or more candidate physical downlink shared channel (PDSCH) receptions or one or more semi-persistent scheduling (SPS) PDSCH releases.

In yet another exemplary aspect, the above-described methods are embodied in the form of processor-executable code and stored in a non-transitory computer-readable storage medium. The code included in the computer readable storage medium when executed by a processor, causes the processor to implement the methods described in this patent document.

In yet another exemplary embodiment, a device that is configured or operable to perform the above-described methods is disclosed.

The above and other aspects and their implementations are described in greater detail in the drawings, the descriptions, and the claims.

### BRIEF DESCRIPTION OF THE DRAWING

FIG. 1 is a diagram illustrating HARQ feedback information for multiple downlink transmissions being provided at one uplink slot.

FIG. 2 is a diagram illustrating HARQ feedback information for multiple downlink transmissions being provided at multiple uplink slots.

FIG. 3 illustrates an example of multiple downlink transmissions scheduled by a DCI and for which HARQ feedback information can be provided in multiple uplink slots.

FIG. 4 illustrates an example of HARQ feedback information being provided early to improve re-transmission of partial downlink transmissions.

FIG. 5 illustrates an example of grouping of multiple downlink transmissions for reporting HARQ feedback in multiple slots.

FIG. 6 illustrates an example carrier aggregation case in which HARQ feedback information can be provided at multiple uplink slots.

FIG. 7 illustrates an example case in which HARQ feedback information is reported in an uplink slot that is not indicated by a feedback timing indicator.

FIG. 8 shows an exemplary flowchart for providing HARQ feedback information in multiple uplink slots.

FIG. 9 shows an exemplary flowchart for obtaining HARQ feedback information in multiple uplink slots.

FIG. 10 shows an exemplary block diagram of a hardware platform that may be a part of a network device or a communication device.

FIG. 11 shows an example of wireless communication including a base station (BS) and user equipment (UE) based on some implementations of the disclosed technology.

### DETAILED DESCRIPTION

The example headings for the various sections below are used to facilitate the understanding of the disclosed subject matter and do not limit the scope of the claimed subject matter in any way. Accordingly, one or more features of one example section can be combined with one or more features of another example section. Furthermore, 5G terminology is used for the sake of clarity of explanation, but the techniques disclosed in the present document are not limited to 5G technology only, and may be used in wireless systems that implemented other protocols.

Extended Reality (XR) generally refers to combinations of real and virtual environments, and includes Augmented Reality (AR), Mixed Reality (MR), or Virtual Reality (VR). The technology of XR combines the real world with virtual information generated by digital device. In this way, XR enables user perceived immersive experience in a mixed real-virtual environment. To support the high-quality XR service, relatively high date rate and low latency of a network is required.

As such, techniques regarding improving system capacity have been considered. For example, a single downlink control information (DCI) scheduling multiple transport blocks (TBs) can improve network capacity due to saving physical downlink control channel (PDCCH) overhead, assuming the downlink (DL) stream is pseudo-periodic and with large scale of packet size (e.g., several slots would be scheduled for a packet transmission).

For hybrid acknowledgement repeat request (HARQ) for the multiple downlink transmissions scheduled by the DCI, a network device or wireless communication node (e.g., a gNodeB, a base station) provides a HARQ feedback timing indicator, in existing techniques. For example, the HARQ feedback timing indicator is a bit field that indicates a KI value that denotes a time gap between the last scheduled downlink transmission and an UL slot for a HARQ report or feedback.

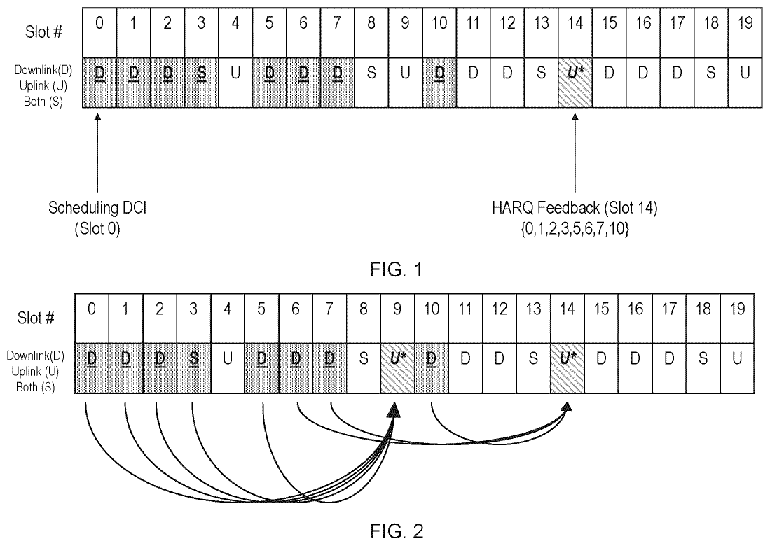

FIG. 1 illustrates an example of transmitting a HARQ report or feedback in an UL slot at a time after the last scheduled DL transmission. As illustrated in FIG. 1, a DCI in slot 0 schedules eight downlink transmissions, the last one of which scheduled for DL slot 10. HARQ acknowledgements (HARQ-ACKs) or negative acknowledgements (HARQ-NACKs) for the downlink transmissions are transmitted in UL slot 14 after the last downlink transmission in slot 10. For example, the HARQ feedback is transmitted in UL slot 14 based on a KI value of 4.

Because the HARQ feedback is not transmitted to the network device or wireless communication node until a time after the last scheduled downlink transmission, a re-transmission by the network device is delayed. For example, in the illustrated example of FIG. 1, a re-transmission cannot be scheduled until downlink slot 15 at the earliest, even if the re-transmission is a repeat of the DL transmission of slot 2. Thus, a need to address latency resulting from existing HARQ feedback techniques exists. Such latency further causes degradation of downlink performance and capacity.

Embodiments described herein provide technical solutions to issues of delay of HARQ reports in an uplink slot when a DCI scheduled multiple downlink transmissions, such as physical downlink shared channels (PDSCHs). In some embodiments, HARQ-ACK (or HARQ-NACK) is reported in multiple slots according to corresponding groups of the scheduled downlink transmissions. Accordingly, delay of HARQ-ACK for a group of PDSCHs can be reduced. Partial DL transmission can be retransmitted earlier if not detected correctly by the recipient, thus improving the capacity of DL transmission.

### Example Embodiment 1

According to example embodiments, for a multiple DL transmissions (e.g., PDSCHs) scheduled by a DCI, HARQ feedback is transmitted in multiple UL slots by the DL recipient, such as a wireless communication device or a user equipment (UE). In some examples, the UL slots for HARQ feedback are between various DL slots scheduled for the multiple DL transmission.

In particular, embodiments described herein are directed to timing of HARQ feedback (e.g., HARQ-ACKs and HARQ-NACKs).

Case 1-1: In some embodiments, a UE is indicated that HARQ feedback should be transmitted in multiple slots.

In some embodiments, the UE is indicated to provide HARQ feedback in multiple slots via one or more bits in a downlink control information (DCI) that schedules the downlink transmissions and that is received by the UE. For example, one bit in the DCI indicates to the UE to enable multi-slot HARQ feedback instead of single-slot HARQ feedback. For example, a number of bits (e.g., three) are used to indicate a PDSCH-to-HARQ timing indicator.

In some embodiments, the UE is indicated to provide multi-slot HARQ feedback via a radio resource control (RRC) signaling, via a media access control (MAC) control element (CE), and/or the like.

FIG. 2 provides an example of multi-slot HARQ feedback, or transmitting HARQ-ACKs (or NACKs) in multiple slots. In the illustrated example, the time division duplex (TDD) configuration is DDDSU, with “D” denoting a downlink slot, “U” denoting an uplink slot, and “S” denoting a flexible slots that can be either a downlink slot or an uplink slot.

In FIG. 2, HARQ feedback for downlink transmissions (e.g., a PDSCH reception, PDSCH releases) in slots 0, 1, 2, 3, and 5 are transmitted in uplink slot 9. HARQ feedback for downlink transmissions in slots 6, 7, and 10 are transmitted in uplink slot 14.

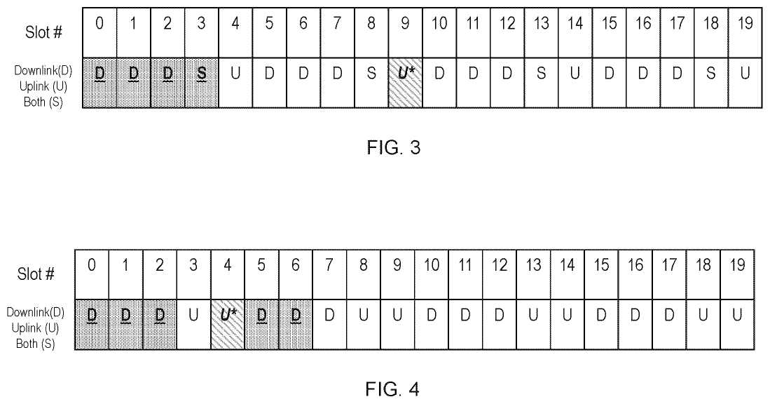

Example embodiments include other UE behaviors in addition to being indicated to enable multi-slot HARQ feedback. In some embodiments, the UE determines a set of occasions for candidate PDSCH receptions or SPS PDSCH releases. In some embodiments, the UE generates ACK or NACK for these occasions and generates a HARQ-ACK codebook that includes feedback information. In some embodiments, the UE transmits the codebook to a base station (e.g., a gNodeB) in an uplink slot that is indicated by the DCI (e.g., via a PDSCH-to-HARQ timing indicator). Embodiments described herein may refer to PDSCH receptions or PDSCH releases for purposes of clarity; however, it will be understood that embodiments are applicable to various other downlink transmissions and HARQ feedback thereof.
Case 1-1(A): For one DCI scheduling N number of PDSCHs (when Nis small, e.g., N=4), the UE is indicated that HARQ-ACK should be transmitted in multiple slots. FIG. 3 illustrates an example of a scheduling DCI in slot 0 with PDSCH receptions in slots 0, 1, 2, and 3 (e.g., N=4). In some embodiments, the HARQ-ACK to PDSCH receptions in slots 0, 1, and 2 can be transmitted in uplink slot 4, and HARQ-ACK to PDSCH reception in slot 3 can be transmitted in slot 9. In this way, the chance of re-transmission of transport blocks transmitted in downlink slots 0, 1, and 2 is increased, if the transport blocks were not detected correctly. Thus, example embodiments provide benefits with respect to performance of capacity.
Case 1-1(B): In some embodiments, the UE can be indicated that HARQ-ACK should be transmitted in multiple slots for different TDD configurations. FIG. 4 illustrates an example of a TDD configuration that is DDDUU. In the example TDD configuration shown in FIG. 4, there are more UL slots (compared to the TDD configuration of FIG. 3), and as such, there are less re-transmission opportunities for PDSCH. Accordingly, embodiments described herein for enhancing HARQ feedback provides benefits because HARQ-ACK is reported in time and DL slots can be made most full use of. For example, HARQ-ACK for slots 0, 1, and 2 is reported in uplink slot 4, which occurs before the remaining scheduled downlink transmissions in slots 5 and 6.
Case 1-1(C): In some embodiments, different slot format indicator (SFI) configuration provides flexible UL-DL symbols/slot configuration. For example, an SFI-index field value in a DCI format 2_0 indicates to a UE a slot format for each slot in a number of slots for each DL bandwidth part (BWP) or each UL BWP starting from a slot where the UE detects the DCI format 2_0. In this case, if additional UL slots or symbols exist in the duration between scheduled PDSCHs and the only indicated UL slot for HARQ-ACK feedback, it would be possible to report HARQ-ACK for partial PDSCHs (e.g., a first group of PDSCHs) earlier.
Case 1-2: In some embodiments, the UE does not expect to receive a PDSCH-to-HARQ timing indicator, or the UE fails to receive the PDSCH-to-HARQ timing indicator. Then, assuming the last DL slot n is indicated, the UL slot with a minimal time gap (e.g., a time gap greater than 1 slot) from the last DL slot n can be selected as the UL slot for HARQ-ACK reporting. Case 1-3: In some embodiments, the UE is indicated implicitly that HARQ-ACK should be transmitted in multiple slots. In some embodiments, the implicit indication is based on whether two conditions are met. The first condition is if an UL slot x exists between the scheduling DCI and the UL slot indicated by the PDSCH-to-HARQ timing indicator. The second condition is if the time gap between the scheduling DCI and the UL slot x is equal or larger than a minimal time gap, e.g., the value 1 slot.

### Example Embodiment 2

Embodiments described herein are directed to how to group PDSCHs candidates. Embodiments described herein are directed to grouping of the multiple DL transmissions (e.g., PDSCHs) for multi-slot HARQ feedback.
Method 1: In some embodiments, the scheduled downlink slots are classified into groups or subsets based on a minimal processing delay. In some embodiments, the minimal processing delay is configured by a RRC signaling. In some embodiments, the minimal processing delay is indicated by the DCI.

In some embodiments, an UL slot is determined based on a time gap of minimal processing delay for reporting HARQ-ACK to a plurality of PDSCHs. For example, a first group of PDSCHs is determined for a first UL slot, if the time gap between a last PDSCH of the first group and the first UL slot is equal or larger than a minimal time gap (e.g., the value 1 slot). Then, with similar regulation, subsequent groups of PDSCHs can be determined for subsequent UL slots.

In some embodiments, the HARQ-ACK to a last group or subset of PDSCHs is transmitted in the slot indicated by the PDSCH-to-HARQ timing indicator.
Method 2: In some embodiments, the scheduled downlink slots are classified into two groups or subsets.

In some embodiments, the UE determines a UL slot y via a PDSCH-to-HARQ timing indicator. The UE determines a UL slot x that is the latest UL slot before the UL slot y as another UL slot for reporting HARQ-ACK to PDSCH receptions or PDSCH releases.

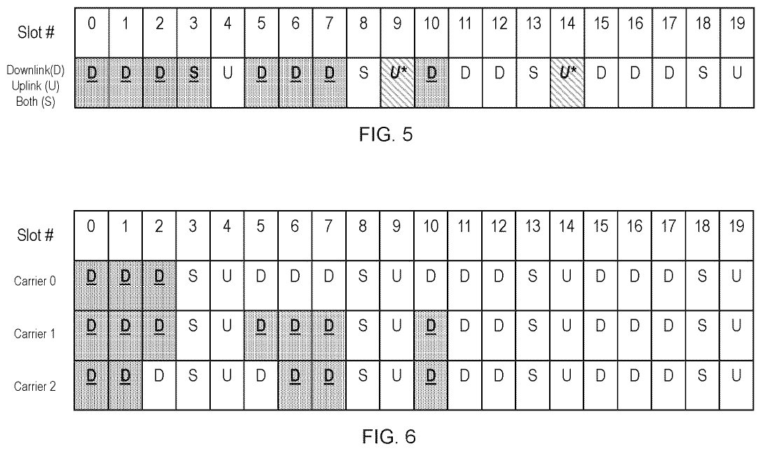

FIG. 5 illustrates an example of grouping features according to classifying scheduled downlink slots into two groups. For example, a UL slot y is determined via PDSCH-to-HARQ timing indicator (e.g., slot 14), and another UL slot x is determined (e.g., slot 9). A series of DL slots belong to the first group, e.g., slots 0, 1, 2, 3, and 5 in FIG. 5. The last DL slot of the first group is >=N slots from the UL slot x, which is determined for transmitted HARQ-ACK feedback for the first group of PDSCHs. For example, slot 5 is 4 slots from slot 9, with N=4. In another case, N=2 and the first group of PDSCHs is slots 0, 1, 2, 3, 5, 6, and 7.

In some embodiments, a N1 constraint may be configured via RRC configuration. For example, the number of PDSCHs in each group is not larger than NI. In some examples, N1=max scheduling_PDSCHs/2, or N1 is half of the total number of scheduled PDSCHs. In this way, the size of Type 1 codebook can be reduced.

In some embodiments, the UE determines another UL slot (e.g., slot x) via an indication of an offset from an UL slot y. In some examples, the value of the offset can be between one to eight slots.
Method 3: In some embodiments, an indication for the groups of downlink slots is provided.

In some embodiments, the UE is indicated a start slot x and an end slot y. With the start and end slots, the scheduled PDSCHs can be divided into two groups if the end slot y is the same as the UL slot indicated via the PDSCH-to-HARQ timing indicator. Otherwise, the scheduled PDSCHs can be divided into three groups. In some embodiments, more than two slots x and y can be indicated to divide the scheduled PDSCHs into more than three groups.
Method 4: In some embodiments, some of the downlink transmissions are scheduled for consecutive slots. If N consecutive PDSCHs are scheduled/transmitted, the first N−1 PDSCHs are a first subset and the N-th PDSCH is a second subset. Thus, for example, the first N−1 PDSCHs are acknowledged in a first uplink slot, and the N-th PDSCH is acknowledged in a second uplink slot.

### Example Embodiment 3

In particular, embodiments described herein are directed to optimizations and improvements to codebook structures for reporting HARQ feedback.
Case 3-1: Type 1 codebook.

In some embodiments, a first codebook is transmitted in a first UL slot x for a first group of PDSCH receptions, and a second codebook is transmitted in a second UL slot y for a second group of PDSCH receptions.

In some embodiments, the size of Type 1 HARQ-ACK codebook can be dynamic, and can be indicated by dynamic signaling. In an embodiment, the UE is indicated the size of the HARQ-ACK codebook corresponding to a group of PDSCHs. For example, 2 bits in a DCI indicate the size of the HARQ-ACK codebook that conveys feedback to the first group of PDSCHs.
Case 3-1(A): In some embodiments, multi-slot HARQ feedback is enabled for carrier aggregation cases. FIG. 6 illustrates an example of a carrier aggregation case in which multi-slot HARQ feedback is used. In the illustrated example, one DCI schedules three PDSCHs for carrier 0, one DCI schedules eight PDSCHs for carrier 1, and for carrier 2, one DCI schedules 2 PDSCHs while another DCI schedules three PDSCHs.

In some embodiments, the UE reports a HARQ-ACK value if the DL slot is received correctly or a HARQ-NACK value if the DL slot is not received correctly. The HARQ-ACK and HARQ-NACK values are for HARQ-ACK information bit(s) in a HARQ-ACK codebook that the UE transmits in a slot not indicated by a value of a PDSCH-to-HARQ-feedback timing indicator field in a corresponding DCI format.

Thus, in the illustrated example of FIG. 6, the downlink slots 0, 1, and 2 of carrier 1 can be acknowledged in uplink slot 4, with ACK/NACK values according to whether the PDSCH/SPS release is received correctly or not. In some embodiments, a subset of downlink transmissions mapped to an uplink slot for acknowledgement includes downlink transmissions for one or more different carriers.
Case 3-2: Type 2 codebook.

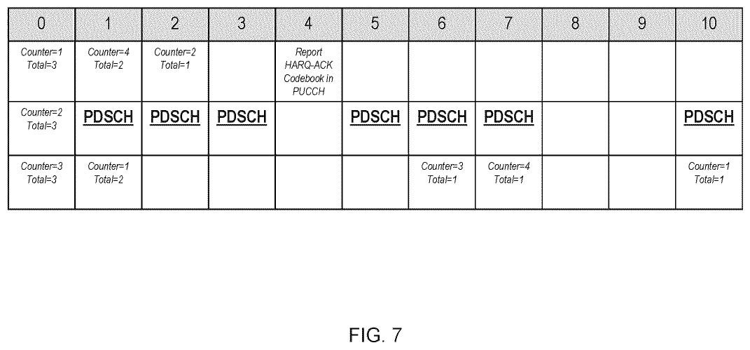

In some embodiments, for carrier aggregation cases, downlink assignment index (DAI) counters are used. The UE can determine whether DCI is mis-detected based on the indicated DAIs from a base station (e.g., a gNodeB). The UE can generate HARQ-ACK information bit(s) in a HARQ-ACK codebook according to whether the PDSCH/SPS release is received correctly or not. In the illustrated example of FIG. 7, the UE generates HARQ-ACK information bit(s) for PDSCH receptions in slots 0, 1, 2, and 3 for reporting in slot 4, despite a PDSCH-to-HARQ feedback timing indicator field indicating to report HARQ-ACK in slot 14. Thus, HARQ acknowledgement information is provided earlier for improving network performance. In some embodiments, the DAI counter is used to map a subset of downlink transmissions to an uplink slot for acknowledgement.

### Example Operations and Implementations

As discussed herein, embodiments provide enhanced techniques and mechanisms for HARQ-ACK. Example embodiments provide various technical benefits. For example, a base station can receive HARQ-ACK information (e.g., ACK or NACK feedback) in time, allowing the base station to have sufficient time to schedule re-transmission and execute link adaption. Otherwise, without HARQ-ACK information being provided in multiple slots at an earlier time, a base station cannot schedule re-transmission until the end of a plurality of PDSCH transmissions (e.g., up to eight PDSCH transmissions). Moreover, embodiments described herein do not increase overhead of HARQ-ACK reports.

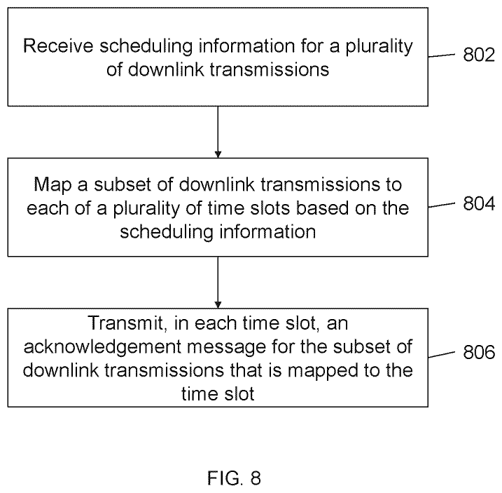

FIG. 8 shows an exemplary flowchart for a method for providing HARQ feedback in multiple slots. In some examples, operations of the flowchart may be performed to enable earlier re-transmission of partial downlink transmissions, thus improving network performance and capacity. In some examples, the method illustrated in FIG. 8 may be performed by a wireless communication device, a user equipment (UE), a terminal, and/or the like. In some embodiments, the plurality of downlink transmissions include one or more candidate physical downlink shared channel (PDSCH) receptions or one or more semi-persistent scheduling (SPS) PDSCH releases.

Operation 802 includes receiving scheduling information for a plurality of incoming (e.g., downlink) transmissions. The scheduling information is received from a network device (e.g., a gNodeB, a base station). In some embodiments, the scheduling information is a downlink control information (DCI) scheduling multiple PDSCH receptions and/or SPS PDSCH releases.

Operation 804 includes mapping a subset of the incoming (e.g., downlink) transmissions to each of a plurality of time slots based on the scheduling information. For example, the plurality of time slots are uplink slots that are interspersed among downlink slots indicated in the scheduling information. For example, at least one of the plurality of time slots occurs before a final incoming transmission. In some embodiments, at least one of the plurality of time slots is before a time slot that is a minimum time offset after an end of the plurality of downlink transmissions. In some embodiments, the plurality of time slots are after a time slot that is a minimum time offset after a start of the plurality of downlink transmissions.

In some embodiments, operation 804 further includes identifying the plurality of time slots to which subsets of downlink transmissions are mapped. The plurality of time slots are identified for transmission of hybrid automatic repeat request (HARQ) acknowledgement messages in response to the mapped subset of downlink transmissions.

In some embodiments, mapping the subset to each time slot is performed in response to receiving an instruction for transmission of acknowledgement messages in multiple time slots from the network device. In some embodiments, mapping the subset to each time slot is performed in response to not receiving an acknowledgement timing parameter that indicates a given time offset for transmission of one acknowledgement message for the plurality of downlink transmissions after an end of the plurality of downlink transmissions. In some embodiments, mapping the subset to each time slot is performed in response to determining that one or more time slots exist between a time slot at which the scheduling information was received and a last time slot that is indicated by an acknowledgement timing parameter.

In some embodiments, each subset is determined to include downlink transmissions that each occur at least a minimum delay before the mapped time slot for transmission of the acknowledgement message for the subset. In some embodiments, the minimum delay is indicated by a received radio resource control (RRC) signaling or by the scheduling information.

In some embodiments, subsets of downlink transmissions are mapped to the plurality of time slots based on: identifying the plurality of time slots to be a first time slot and a second time slot, and mapping a first subset to the first time slot and a second subset to the second time slot based on assigning each of the plurality of downlink transmissions to one of the first time slot or the second time slot. The second time slot is indicated by the scheduling information, and the first time slot is the latest time slot before the second time slot. In some embodiments, each downlink transmission is assigned to one of the first time slot or the second time slot based on whether the downlink transmission occurs at least a minimum delay before the first time slot or the second time slot.

In some embodiments, the subset is mapped to each of the plurality of time slots based an indication of two or more particular time slots that divide the plurality of downlink transmissions into subsets.

In some embodiments, operation 804 includes: identifying a N number of downlink transmissions scheduled for consecutive time slots; mapping a first subset that includes a first N−1 downlink transmissions to a first time slot; and mapping a second subset that includes a N-th downlink transmission to a second time slot.

In some embodiments, a number of downlink transmissions in the subset mapped to each of the plurality of time slots is less than a threshold number. In some embodiments, the threshold number is less than or equal to half of a total number of the plurality of downlink transmissions.

Operation 806 includes transmitting, in each time slot of the plurality of time slots, an acknowledgement message for the subset of the downlink transmissions that is mapped to the time slot. The acknowledgement message in each time slot is transmitted to the network device.

In some embodiments, the example method includes determining whether each of the plurality of downlink transmissions was received correctly; and generating, for each downlink transmission belonging to the subset mapped to a given time slot, an acknowledgement value (ACK) or a negative acknowledgement value (NACK) in the acknowledgement message depending on whether the downlink transmission was received correctly. In some embodiments, operation 806 includes transmitting the acknowledgement message at a time slot that is not indicated by a value of a PDSCH-to-HARQ feedback timing indicator.

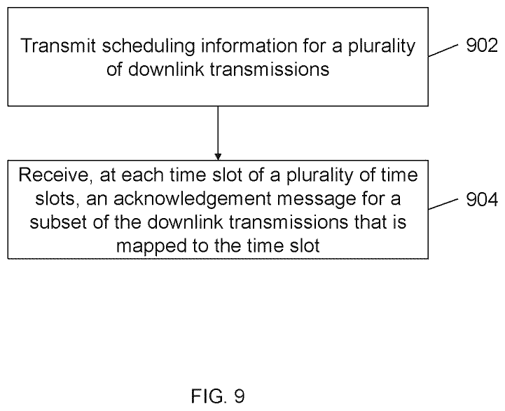

FIG. 9 shows an exemplary flowchart for a method for obtaining HARQ feedback in multiple slots. In some examples, operations of the flowchart may be performed to enable earlier re-transmission of partial downlink transmissions, thus improving network performance and capacity. In some examples, the method illustrated in FIG. 8 may be performed by a network device, a base station, a wireless communication node, and/or the like.

Operation 902 includes transmitting scheduling information for a plurality of outgoing (e.g., downlink) transmissions. The scheduling information is transmitted to a wireless communication device. In some embodiments, the plurality of downlink transmissions includes one or more candidate physical downlink shared channel (PDSCH) receptions or one or more semi-persistent scheduling (SPS) PDSCH releases.

Operation 904 includes receiving, in each time slot of a plurality of time slots, an acknowledgement message for a subset of the outgoing transmissions that is mapped to the time slot. In some embodiments, the mapping of the subset to the time slot is determined based on the scheduling information. In some embodiments, the mapping of the subset to the time slot is determined by the wireless communication device. In some embodiments, at least one of the plurality of time slots in which the acknowledgement message is received is before a time slot that is a minimum time offset after an end of the plurality of downlink transmission. In some embodiments, the plurality of time slots are after a time slot that is a minimum time offset after a start of the plurality of downlink transmissions.

In some embodiments, the example method includes transmitting, to the wireless communication device, an instruction for transmission of acknowledgement messages across the plurality of time slots.

In some embodiments, the example method includes transmitting, to the wireless communication device, an indication of two or more particular time slots that divide the plurality of downlink transmissions into subsets.

In some embodiments, the example method includes transmitting, to the wireless communication device, an indication of a number of the plurality of downlink transmissions to include in the subset that is mapped to each time slot.

In some embodiments, the example method includes constraining a number of downlink transmissions for the subset that is mapped to each time slot to be less than or equal to half of a total number of the plurality of downlink transmissions.

In some embodiments, the example method includes decoding the acknowledgement message that is received at a given time slot to determine whether each of the subset of the downlink transmissions was received correctly by the wireless communication device. In some embodiments, the acknowledgment message is decoded based on the acknowledgement message including a HARQ-ACK value or a HARQ-NACK value that indicates whether or not each downlink transmission was received correctly by the wireless communication device.

In some embodiments, the example method includes scheduling a re-transmission of a particular downlink transmission that is indicated with a HARQ-NACK value in acknowledgement message.

FIG. 10 shows an exemplary block diagram of a hardware platform 1000 that may be a part of a network device (e.g., base station) or a communication device (e.g., a user equipment (UE)). The hardware platform 1000 includes at least one processor 1010 and a memory 1005 having instructions stored thereupon. The instructions upon execution by the processor 1010 configure the hardware platform 1000 to perform the operations described in FIGS. 1 to 9 and in the various embodiments described in this patent document. The transmitter 1015 transmits or sends information or data to another device. For example, a network device transmitter can send a message to a user equipment. The receiver 1020 receives information or data transmitted or sent by another device. For example, a user equipment can receive a message from a network device.

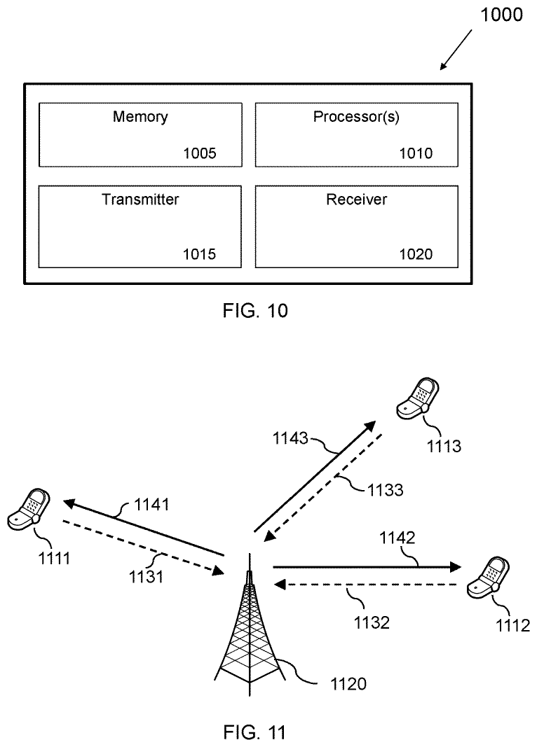

The implementations as discussed above will apply to a wireless communication. FIG. 11 shows an example of a wireless communication system (e.g., a 5G or NR cellular network) that includes a base station 1120 and one or more user equipment (UE) 1111, 1112 and 1113. In some embodiments, the UEs access the BS (e.g., the network) using a communication link to the network (sometimes called uplink direction, as depicted by dashed arrows 1131, 1132, 1133), which then enables subsequent communication (e.g., shown in the direction from the network to the UEs, sometimes called downlink direction, shown by arrows 1141, 1142, 1143) from the BS to the UEs. In some embodiments, the BS send information to the UEs (sometimes called downlink direction, as depicted by arrows 1141, 1142, 1143), which then enables subsequent communication (e.g., shown in the direction from the UEs to the BS, sometimes called uplink direction, shown by dashed arrows 1131, 1132, 1133) from the UEs to the BS. The UE may be, for example, a smartphone, a tablet, a mobile computer, a machine to machine (M2M) device, an Internet of Things (IoT) device, and so on.

In this document the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog and/or digital components that are, for example, integrated as part of a printed circuit board. Alternatively, or additionally, the disclosed components or modules can be implemented as an Application Specific Integrated Circuit (ASIC) and/or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware or firmware. The connectivity between the modules and/or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few implementations and examples are described and other implementations, enhancements and variations can be made based on what is described and illustrated in this disclosure.

1. A method for wireless communication, comprising:
receiving, by a wireless communication device from a network device, scheduling information for a plurality of downlink transmissions;
mapping a subset of the plurality of downlink transmissions to each of a plurality of time slots based on the scheduling information; and
transmitting, in each time slot of the plurality of time slots, an acknowledgement message for the subset of downlink transmissions that is mapped to the time slot to the network device.

2. The method of claim 1, wherein at least one of the plurality of time slots is before a time slot that is a minimum time offset after an end of the plurality of downlink transmissions.

3. The method of claim 1, wherein the plurality of time slots are after a time slot that is a minimum time offset after a start of the plurality of downlink transmissions.

4. The method of claim 1, further comprising:
identifying the plurality of time slots to which subsets of downlink transmissions are mapped, wherein the plurality of time slots are identified for transmission of hybrid automatic repeat request (HARQ) acknowledgement messages in response to the mapped subset of downlink transmissions.

5. The method of claim 1, wherein mapping the subset to each time slot is performed in response to receiving an instruction for transmission of acknowledgement messages in multiple time slots from the network device.

6. The method of claim 1, wherein mapping the subset to each time slot is performed in response to not receiving an acknowledgement timing parameter that indicates a given time offset for transmission of one acknowledgement message for the plurality of downlink transmissions after an end of the plurality of downlink transmissions.

7. The method of claim 1, wherein mapping the subset to each time slot is performed in response to determining that one or more time slots exist between a time slot at which the scheduling information was received and a last time slot that is indicated by an acknowledgement timing parameter.

8. The method of claim 1, wherein each subset is determined to include downlink transmissions that each occur at least a minimum delay before the mapped time slot for transmission of the acknowledgement message for the subset.

9. The method of claim 8, wherein the minimum delay is indicated by a received radio resource control (RRC) signaling or by the scheduling information.

10. The method of claim 1, wherein subsets of downlink transmissions are mapped to the plurality of time slots based on:
identifying the plurality of time slots to be a first time slot and a second time slot,
wherein the second time slot is indicated by the scheduling information, and
wherein the first time slot is a latest time slot before the second time slot; and
mapping a first subset to the first time slot and a second subset to the second time slot based on assigning each of the plurality of downlink transmissions to one of the first time slot or the second time slot.

11. The method of claim 10, wherein each downlink transmission is assigned to one of the first time slot or the second time slot based on whether the downlink transmission occurs at least a minimum delay before the first time slot or the second time slot.

12. The method of claim 1, wherein the subset is mapped to each of the plurality of time slots based an indication of two or more particular time slots that divide the plurality of downlink transmissions into subsets.

13-18. (canceled)

19. A method for wireless communication, comprising:
transmitting, by a network device to a wireless communication device, scheduling information for a plurality of downlink transmissions; and
receiving, from the wireless communication device and in each time slot of a plurality of time slots, an acknowledgement message for a subset of the downlink transmissions that is mapped to the time slot.

20. The method of claim 19, wherein at least one of the plurality of time slots in which the acknowledgement message is received is before a time slot that is a minimum time offset after an end of the plurality of downlink transmission.

21. The method of claim 19, wherein the plurality of time slots are after a time slot that is a minimum time offset after a start of the plurality of downlink transmissions.

22. The method of claim 19, further comprising:
transmitting, to the wireless communication device, an instruction for transmission of acknowledgement messages across the plurality of time slots.

23. The method of claim 19, further comprising:
transmitting, to the wireless communication device, an indication of two or more particular time slots that divide the plurality of downlink transmissions into subsets.

24. The method of claim 19, further comprising:
transmitting, to the wireless communication device, an indication of a number of the plurality of downlink transmissions to include in the subset that is mapped to each time slot.

25-29. (canceled)

30. An apparatus for wireless communication comprising a processor, configured to implement a method recited in claim 1.

31. (canceled)

32. An apparatus for wireless communication comprising a processor, configured to implement a method recited in claim 19.
